(19) United States
(12) Patent Application Publication
(10) Pub. No.: US 2016/0066720 A1
(43) Pub. Date: Mar. 10, 2016

(54) CLOSING PART FOR A BEVERAGE CONTAINER

(71) Applicant: MASTRAD, Paris (FR)

(72) Inventors: ANNE TANGUY, Paris (FR); MATHIEU LION, PARIS (FR)

(73) Assignee: MASTRAD, S.A., Paris (FR)

(21) Appl. No.: 14/786,040

(22) PCT Filed: Apr. 16, 2014
(86) PCT No.: PCT/FR2014/050928

§ 371 Date: Nov. 13, 2015

(30) Foreign Application Priority Data
Apr. 22, 2013 (FR) 1353639

(51) Int. Cl. A47G 19/22; A61J 9/00; A61J 11/04

(52) U.S. Cl. CPC A47G 19/2266; A61J 11/045; A61J 9/006

(57) ABSTRACT

The present invention relates to a closing part (1) for beverage containers, which includes a generally tubular cover (3) made of a food-grade sealing elastomer material. A first end is closed by an end portion (5) in which an opening (51) for dispensing the beverage is provided. The second end (41) of the cover (3) is arranged such as to be connected to a container. Near said second end (41), the cover (3) has a portion (43) which is flared in the direction of the second end (41). The shape of said flared portion (43) and the constitutive material thereof, along with the thicknesses and elastic characteristics thereof, are determined together in order to allow for a plurality of elastic deformation ranges or the flared portion (43) depending on which portion thereof is deformed in a state of connection to a container. The closing part sealingly fits onto an assortment or containers having different sizes.

The invention relates to the field of cooking utensils and accessories, and more particularly to containers which are designed for beverages.

Containers for beverages have various forms, compositions and structures. Ranging from a simple disposable goblet to a thermos for coffee, each type of beverage container is designed for particular conditions of use. The storage cabinets and spaces available, in particular in the kitchens of the users, are quickly filled by a multitude of utensils, and in particular containers. It is thus desirable to design kitchen utensils which take up little space when stored.

These matters of storage affect most particularly the parents of young children and/or large families. In these situations, the utensils specific to the young children are added to the conventional utensils. As the children grow and develop, it is necessary to replace the accessories specific to childcare according to the age range of the children. The accessories necessarily accumulate, in the commonly occurring case of a family with two or three young children who are close together in age.

In fact, a young child goes progressively from the stage of suckling by means of sucking-deglutition of the nursing infant type (also known as infantile deglutition or primary deglutition) to the stage of acquisition of deglutition of the “toothed subject” type (also known as “adult deglutition”), when milk teeth are acquired. This morphological and pedagogical development involves the availability of a varied range of beverage containers and other accessories. And the accumulation of feeding bottles and other containers contributes to the overcrowding of the directly accessible storage space.

In addition, the complexity of these containers and the number of spare parts makes the assembly, dismantling and cleaning cumbersome, with resulting hygiene risks.

Each time a person goes out they must also take these accessories with them, and the accessories must therefore have substantial mechanical strength, and withstand impacts and being dropped, whilst remaining light and compact.

In order to allow the child to learn to drink alone, and safely, the container must firstly protect the intactness of the beverage relative to the external environment, and secondly prevent the user from being soiled by the content.

These constraints have led protagonists in the sector to distinguish beverage containers designed for children from those designed for adults, at the design stage. This pronounced differentiation of the objects curbs the learning and mimicry of children who see an adult drinking from a glass. Their development is slowed down.

Beverage containers for children generally comprise a plurality of parts which are mutually adapted in order to function together. However, the rate of replacement of childcare products by the manufacturers is significant, and the level of standardization between the products is low. The malfunctioning, loss or breakage of one of these parts means that the whole device has to be replaced. The resulting costs and wastage are difficult to accept.

The objective of the invention is to improve the situation.

The applicant is proposing a closing piece for beverage containers. The closing piece comprises an envelope with a generally tubular form made of food grade sealing elastomer material. This envelope has a first end closed by a final part also made of food grade sealing elastomer material. An output opening to dispense the beverage is provided in this final part. The second end of the envelope is designed to be connected to a container. In the vicinity of this second end, the envelope has a part which is flared in the direction of the second end. The form of this flared part and its component material, with their thicknesses and resilient characteristics, are determined jointly in order to permit a plurality of ranges of resilient deformation of the flared part, according to the portion of it which is deformed in a state in which it is connected to a container. This plurality of deformation ranges is selected in order to make it possible to fit in a sealed manner on a range of containers which have openings with different sizes.

The piece can also have the following characteristics, which are or are not combined with one another:
The plurality of deformation ranges is selected in order to make it possible to fit in a sealed manner on a range of containers which have substantially, circular openings with diameters of between 50 and 100 mm. The closing piece can adapt to a wide range of existing containers. The compatibility of the closing piece is improved.
The first end and the flared part of the envelope are in a single piece and made of a common material. Production is facilitated and production costs are reduced.
The flared part of the envelope comprises a first material. The first end of the envelope comprises a second material with hardness greater than that of the first material. The flared part has a substantial resilient deformation range in order to adapt to a wide range of containers, whereas the top is rigid and has improved strength in use.
The thickness of the flared part of the envelope is between 500 and 1,000 pun. The resistance to tearing and piercing, in particular during use by children, is improved. The quantity of material used is nevertheless moderate. The flexibility of the part is maintained.
Between the end, which is closed by the final part, and the flared part, the envelope comprises a radial restriction towards the interior. The mechanical performance of the part once it has been installed around a container is improved. In particular, the top of the envelope and the buccal end have good mobility, even when the flared part is subjected to substantial stresses.
The envelope comprises silicone with Shore A hardness of between 10 and 70. A material of this type has stability and intactness which make it suitable for contact with foodstuffs, and mechanical properties which are suitable for the deformations envisaged. The production techniques are inexpensive.
The first end of the envelope comprises silicone with Shore A hardness of between 10 and 80. The end tends to resume its original form more easily after deformation, which makes the action of drinking easier.
In the vicinity of the free end of the second end, the envelope comprises a bead extending substantially on a contour, and which projects towards the exterior according to a substantially radial direction. Grasping by the user is facilitated, in particular for the operation of removal of the closing piece from the container.
The end of the second end is without a collar. The material used is reduced, and the risk of accidental removal of the closing piece from the container is reduced. The absence of a collar makes the action of gripping the closing piece less intuitive, thus preventing a child from succeeding on its own in removing the closing piece.
The flared part has an inner clamping surface, the inner clamping surface been provided with at least one rib which extends substantially in a circumferential direction. The friction force between the closing piece and the container is increased, and the force necessary for removal is greater. The removal requires the assistance of an adult, thus preventing accidents.
The final part forms a protuberance relative to the envelope and is connected to the latter by means of a bottleneck, the final part being designed for suckling by suction-deglutition of nursing infant type. A single closing piece associated with one or more containers can then replace a plurality of bulky feeding bottles.
The final part comprises a buccal tip which is designed for drinking by deglutition such as would be done by a subject with milk teeth or adult teeth. Learning the action of drinking is then possible without needing to acquire or store a dedicated container.
The output opening for dispensing the beverage is designed to permit insertion and retention of a straw. Use by an infant obliges it to learn to hold a container according to the usual orientation of a glass, without which it would not be possible to succeed in sucking up the beverage, whilst reducing the risks of tipping the drink out of the container.

Other characteristics, details and advantages of the invention will become apparent from reading the following detailed description, and from the appended drawings, in which:

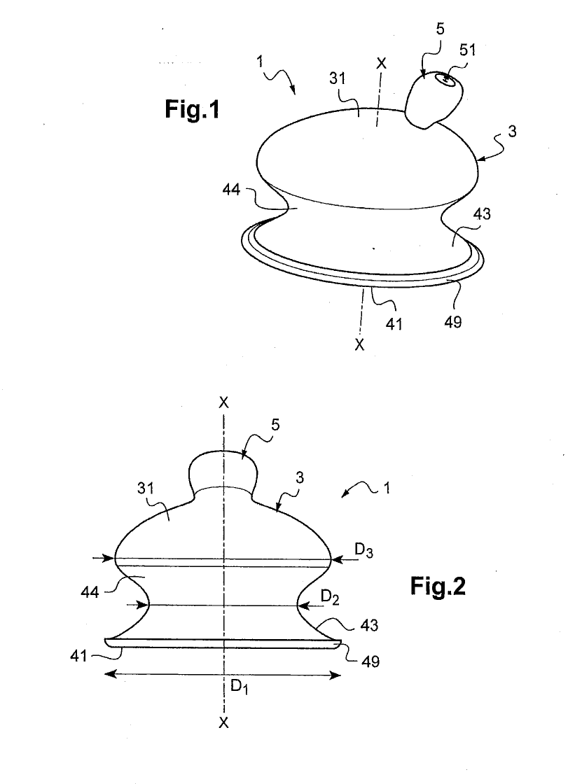

FIG. 1 shows a view in perspective of a closing piece according to a first embodiment of the invention;

FIG. 2 shows a side view of the closing piece in FIG. 1;

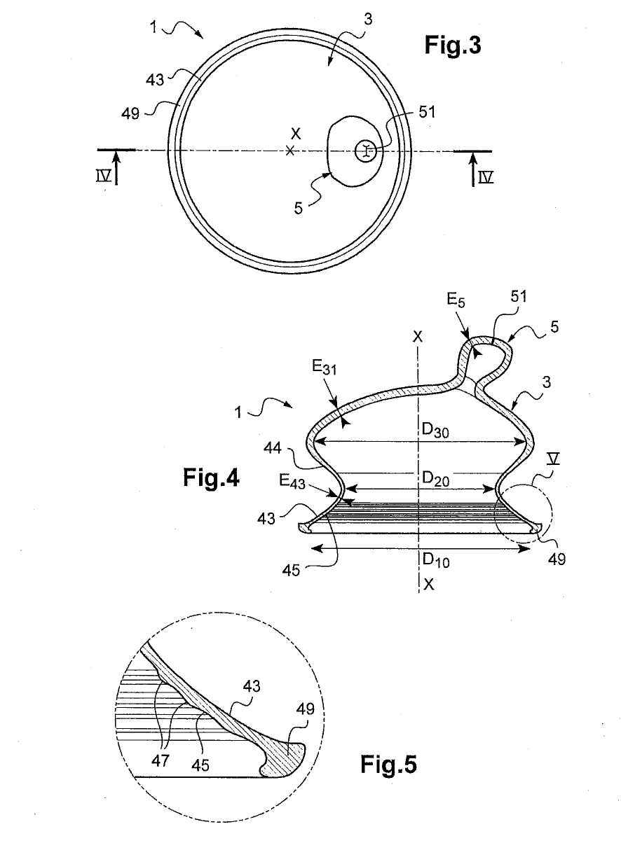

FIG. 3 shows a view from above of the closing piece in FIG. 1;

FIG. 4 shows a view in axial cross section of the closing piece in FIG. 1;

FIG. 5 shows a view of the detail V in FIG. 4;

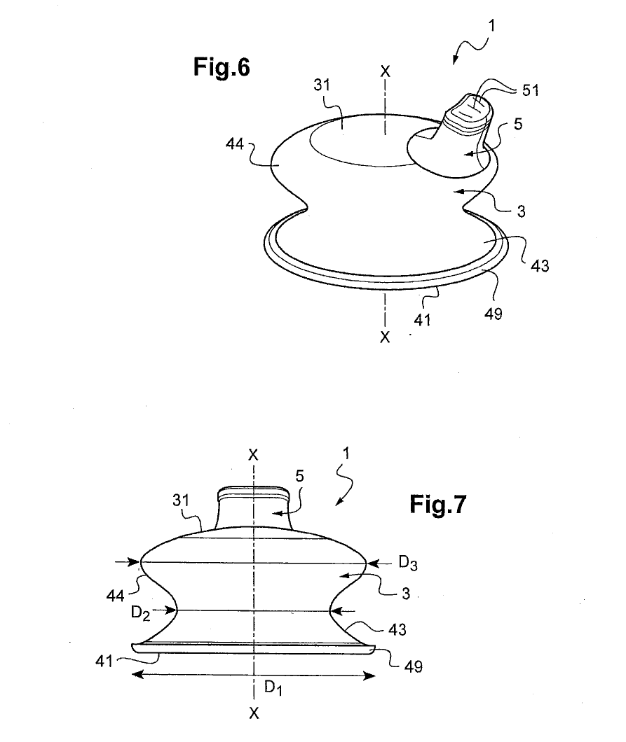

FIG. 6 shows a view in perspective of a closing piece according to a second embodiment of the invention;

FIG. 7 shows a side view of the closing piece in FIG. 6;

FIG. 8 shows a view from above of the closing piece in FIG. 6;

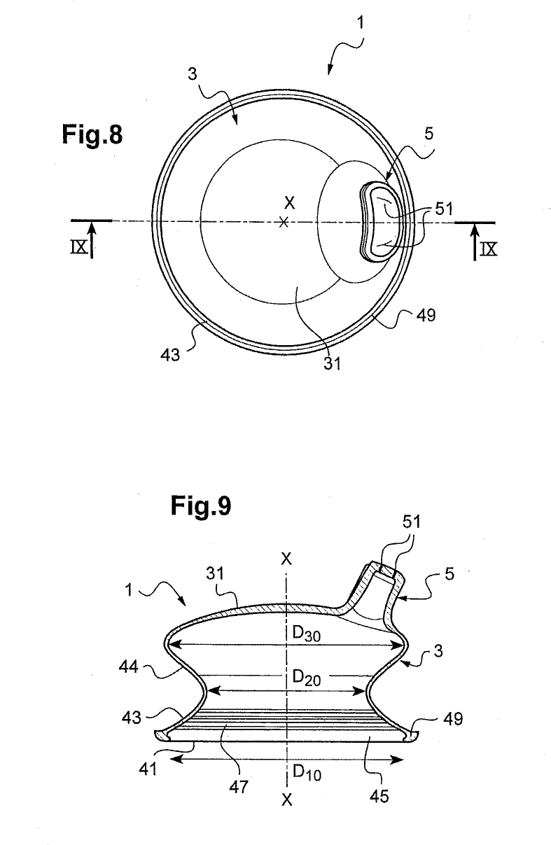

FIG. 9 shows a view in axial cross section of the closing piece in FIG. 6;

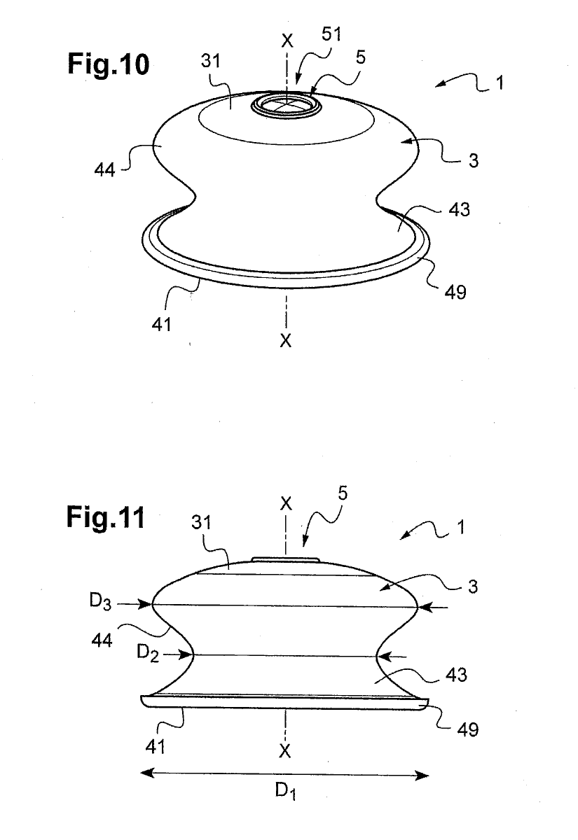

FIG. 10 shows a view in perspective of a closing piece according to a third embodiment of the invention;

FIG. 11 shows a side view of the closing piece in FIG. 10;

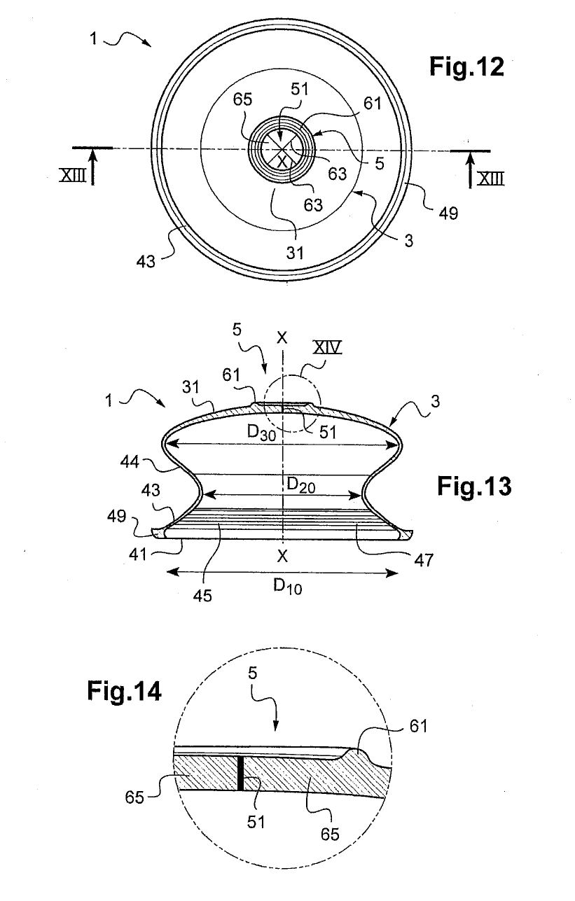

FIG. 12 shows a view from above of the closing piece in FIG. 10;

FIG. 13 shows a view in axial cross section of the closing piece in FIG. 10;

FIG. 14 shows a view of the detail XIV in FIG. 13;

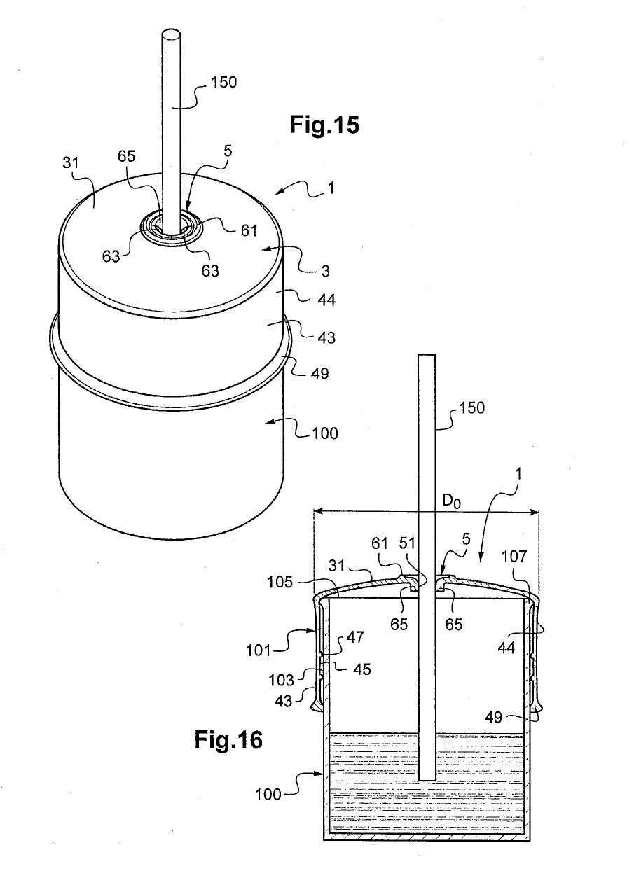

FIG. 15 shows a view in perspective of the closing piece in FIG. 10 in the state in which it is fitted on a container, and through which a straw is inserted; and

FIG. 16 is a view in axial cross section of the assembly in FIG. 15.

The appended drawings comprise elements of a certain nature. They can therefore not only serve to complete the invention, but also contribute towards its definition if applicable. It should be noted that elements such as the geometry, forms and dimensions of the closing piece are difficult to define completely other than by means of the drawing.

In the figures, the closing piece has the reference 1 as a whole, whereas the container has the reference 100 as a whole.

Hereinafter, the terms “top”, “bottom”, “horizontal”, “vertical”, “inner” and “outer” are used with reference to the arrangement and orientation of an assembly of the closing piece 1 and of the container 100 placed on a substantially horizontal surface. A configuration of this type can be seen in FIG. 16.

In FIG. 1, the closing piece 1 comprises an envelope 3 and a final part 5. The envelope 3 has a generally tubular form. By generally tubular form it must be understood that the envelope 3 is in the form of a wall which is closed on itself, so as to delimit an inner space of an outer space and two ends, one of which is upstream relative to the other, which is downstream during functioning. The generally tubular form must not be interpreted as being restricted to a particular orientation, or to a straight or cylindrical form, or to any dimensional ratio between a length and a width. The envelope 3 represented in the figures is substantially of revolution. The form of revolution takes the form in the figures of an axis of revolution XX. The envelope 3 has an upper end 31 and a lower end 41. The upper end 31 is closed by the final part 5. An output opening 51 is provided in the final part 5. The output opening 51 is designed to dispense the beverage.

The lower end 41 is designed to be engaged on the container 100. In the vicinity of the lower end 41, the envelope 3 has a contour of revolution comprising a part 43 which flares towards the exterior in the direction of the lower end 41.

The envelope 3 has a structure and composition which are sealed against fluids and in particular liquids. The envelope 3 comprises a membrane made of elastomer material. Since the closing piece 1 is designed to be in contact with the beverage and optionally in contact with the mouth of a user, the elastomer material is of food grade. Food grade means a material which has properties making it suitable for use in the foodstuffs field, or wherein contact with the food or beverages does not constitute a known risk determined for the health of the consumer. Preferably, the material complies with childcare and health standards in force for use by young children and babies. In the examples described here, the closing piece 1 is made of silicone.

When the closing piece 1 is said “to be made of silicone”, it must be understood to be constituted substantially of silicone. In this case, the closing piece 1 comprises at least 80% by weight, and preferably 95% by weight, of silicone.

In addition to its mechanical properties in terms of deformability, silicone also has good permeability to microwave energy, and a wide range of resistance to heat, for example in a temperature range of between −40 and 250° C., and has low thermal inertia. Use is made for example of the silicone with the reference “Rhodorsil® MF 950 U” with Shore A hardness of 50. As a variant, the silicone can have hardness of between Shore A 10 and 80, for example Shore A 30. Certain elements, such as reinforcement members, parts with a substantially ergonomic or aesthetic nature etc., can be made of a different material, for example a High Temperature Nylon (HTN) with the reference “Zytel® 70G13L NC010” sold by the company DuPont, which withstands the temperatures of treatment of silicone, or of silicone with a hardness greater than Shore A 80. In some variants, the piece 1 comprises natural rubber, synthetic rubber or a thermoplastic elastomer (TPE) which is selected for its resilient properties.

In the embodiment in FIGS. 1 to 4, the upper end 31 of the envelope 3 comprises materials different from the flared part 43 of the envelope 3. The upper end 31 comprises a material with hardness greater than that of the material of the flared part 43 of the envelope 3. The upper end 31 comprises silicone with Shore A hardness of between 10 and 80, for example substantially equal to 50, whereas the flared part 43 of the envelope 3 comprises silicone with Shore A hardness of between 10 and 70, for example substantially equal to Shore A 30. The closing piece 1 is then known as “bi-Shore”. This distinction makes it possible to fulfil the need for the envelope 3 to have substantial extensibility for its fitting on the container 100. As far as the upper end 31 of the envelope 3 is concerned, it is preferable for it to have good strength and for it to resist collapsing under its own weight and that of the final part 5. The composition and structure of the silicone remain substantially homogenous within the envelope 3 on the one hand and within the final part 5 on the other hand.

In the embodiments in FIGS. 6 to 9 and 10 to 14, the envelope 3 and the final part 5 are in a single piece. The envelope 3 and the final part 5 are made based on a common material. The envelope 3 and the final part 5 are made in a single piece by molding of silicone in elastomer form. The composition and structure of the silicone are substantially homogenous between the envelope 3 and the final part 5. This facilitates the production and reduces the costs in comparison with an envelope and an final part made of materials with different hardnesses. The closing piece 1 is then known as “mono-Shore”.

In variants, for example according to the preponderance of criteria of costs or those of mechanical strength, the embodiment in FIGS. 1 to 4 can be “mono-Shore”, and the embodiments in FIGS. 6 to 9 and 10 to 14 can be “bi-Shore”.

Reference is now made at the same time to FIGS. 2, 7 and 11. The envelope 3 of the closing piece 1 has a substantially circular form seen from above.

The envelope 3 has in succession, from the bottom towards the top, an outer diameter D₁, an outer diameter D₂, and an outer diameter D₃. The envelope 3 has the respective inner diameters D₁₀, D₂₀, D₃₀ represented in FIGS. 4, 9 and 13. The flared part 43 extends between the portion with a diameter D₁ and the portion with a diameter D₂. An intermediate flared part 44 is defined between the diameter D₂ and the diameter D₃. This intermediate part 44 flares in the direction opposite that of the flared part 43. The diameter D₂ is smaller than the diameters D₁ and D₃. The diameter of the envelope 3 decreases from the bottom towards the top between the diameter D₁ and the diameter D₂ along the flared part 43, and increases between the diameter D₂ and the diameter D₃ along the intermediate part 44.

Above the intermediate part 44, above the diameter D₃ and as far as the final part 5, the envelope 3 has the general form of a cap or a dome. The diameter decreases from the bottom towards the top, from the diameter D₃ as far as the final part 5. In the embodiments in FIGS. 6 to 9 and 10 to 14, the top of the envelope 3 is substantially flatter than that in FIGS. 1 to 4.

The inner space defined by the envelope 3 has a bottleneck or narrowing at the diameters D₂ and D₂₀. In the examples in FIGS. 4, 9 and 13 in axial cross section, a lateral wall of the envelope 3 has the general form of a catenoid.

As can be seen in the figures in cross section, the closing piece 1 has heterogeneous thicknesses. The flared part 43 has a thickness of between 500 and 1,000 μm. The upper end 31 of the envelope 3 has a thickness of between 500 and 2,000 μm. The final part 5 has a thickness of between 500 and 5,000 μm. As can be seen in FIG. 4, the thicknesses vary substantially continuously from one part to the other of the closing piece 1.

Reference is now made to FIG. 5. The detail which is represented in it belongs to FIG. 4. However, it is similar to details of the embodiments in FIGS. 9 and 13. The flared part 43 has an inner surface 45. The inner surface 45 is in this case a surface of revolution. The inner surface 45 is designed to come at least partially into contact with the container 100. In the state of rest represented in FIG. 5, the inner surface 45 is flared. The inner surface 45 supports ribs 47. The ribs 47 project towards the interior of the envelope 3 from the inner surface 45. The ribs 47 are substantially parallel to one another, and extend in a peripheral direction of the flared part 43. As a variant, the flared part 43 comprises no ribs or a single rib 47. The ribs 47 make it possible to increase the friction force between the inner surface 45 and the container 100 in an assembled state of the closing piece 1 and of the container 100, in order to limit the risk of accidental sliding between the inner surface 45 and the container 100.

The free end of the flared part 43 comprises a bead 49. The bead 49 forms an inner contour and an outer contour of the envelope 3. The bead 49 extends on the circumference of the envelope 3. In this case, the bead 49 forms an excess thickness at the free lower end 41 of the envelope 3.

The part which projects towards the interior of the bead 49 increases the friction force between the lower end 41 of the envelope 3 and the container 100 in an assembled position of the closing piece 1 and of the container 100.

The part which projects towards the exterior of the bead 49 forms a means for grasping of the closing piece. The bead 49 can be used to initiate winding of the envelope 3 around itself, for example during the removal of the closing piece 1 of the container 100. By winding the envelope 3 around the exterior when the closing piece 1 is removed from the container 100, the user does not have to pull on the closing piece 1, which would increase the risk of tearing. The operation of removal of the closing piece 1 is facilitated, for example for cleaning of the assembly. In addition, this operation is not instinctive for a child. Accidental removal of the closing piece 1 by the child is prevented, whereas deliberate removal is facilitated for an adult.

The bead 49 additionally forms a reinforcement of the lower end 41 of the closing piece 1, thus improving its resistance to tearing.

The bead 49 has a thickness of between 2 and 6 mm, for example 4 mm. The bead 49 projects towards the exterior relative to the remainder of the flared part 43. The bead 49 projects radially by a value of less than 4 mm, and preferably less than 3 mm. This limits the quantity of material necessary during production. In particular, the bead 49 is slightly rough to the touch in the installed state, which dissuades a child from using it as a grasping means. The bead 49 is without a surface forming a shoulder which would be substantially radial (perpendicular to the axis of revolution XX). A system for blocking/clamping according to the direction of the axis of revolution XX by the addition of a clamping ring is excluded in this case.

In the example described here, the lower end 41 of the flared part 43 is without a collar. In this case, “collar” means an annular part which projects towards the exterior or towards the interior in a substantially radial direction, and which would form a shoulder with a radial surface sufficient to form a contact-clamping surface according to the direction of the axis of revolution XX, for example by application of a clamping ring. In other words, the closing piece 1 is in this case not designed to come into contact with a container 100 by forming a sealing and clamping surface according to a substantially radial direction. On the contrary, the sealing is provided by the contact of the inner surface 45 on a substantially cylindrical contour of the container 100, and along the circumference, as will be described hereinafter. The bead 49 cannot be assimilated to a collar.

Reference is now made to the embodiment of the final part 5 in FIGS. 1 to 5. In this embodiment, the final part 5 is in the form of a protuberance relative to the envelope 3. The final part 5 is connected to the envelope 3 by means of an end bottleneck or narrowing. The inner space defined in the protuberance of the final part 5 and that defined in the envelope 3 are in fluid communication by means of the end bottleneck. The output opening 51 is provided in the top end of the final part 5.

In the example described here, the final part 5 is eccentric relative to the envelope 3. The final part 5 is arranged spaced from the axis of revolution XX. The final part 5 then forms an exception to the symmetry of revolution of the closing piece 1. As a variant, the final part 5 is centered on the envelope 3.

The forms and dimensions of the opening 51 and the material of the final part 5 are jointly designed such as to close the final part 5 and isolate the interior fluidly from the exterior of the final part 5 in the installed but unused state. In other words, the opening 51 is closed in a state of rest of the final part 5 (even if the closing piece is in the installed state on the container 100), and can be opened by deformation of the final part 5.

In general, the final part 5 of this embodiment is designed for suckling by suction-deglutition of nursing infant type. In particular, the opening 51 is designed in a manner which is reminiscent of the opening of a feeding bottle teat. The embodiment represented in FIGS. 1 to 4 is particularly suitable for nursing infants aged from at least 6 months up to approximately 18 months.

In the embodiment in FIGS. 1 to 5, the structure and composition of the final part 5 are jointly selected in order to generate sealing against the liquid, and prevent leakage of the beverage when the final part 5 is at rest, and to open during suckling by a nursing infant in order to dispense the beverage from the interior of the closing piece 1 to the mouth of the nursing infant.

In a variant, a valve is arranged in the envelope 3. The valve is so-called non-return. The valve is designed to allow air to enter from the exterior to the interior of the closing piece 1, whilst preventing liquid from being discharged from the interior to the exterior via the valve. The valve facilitates the balancing of the pressures between the interior and the exterior. The flow of the beverage is facilitated during use.

Reference is now made to the embodiment in FIGS. 6 to 9. The flared part 43 is similar to that of the embodiment previously described. The final part 5 comprises a buccal tip. The final part 5 is eccentric relative to the envelope 3. The final part 5 is arranged spaced from the axis of revolution XX. The final part 5 thus forms an exception to the symmetry of revolution of the closing piece 1.

The connection between the envelope 3 and the final part 5 is in this case without a bottleneck. The buccal tip is arranged in the continuity of the envelope 3. The final part 5 flares in the direction of the top towards the envelope 3. The inner space of the final part 5 is reminiscent of the form of a funnel which is reduced in the direction of a top end of the buccal tip. The top end of the final part 5 is closed by a substantially flat wall. The end wall of the buccal tip in this case contains three output openings 51 to dispense the beverage. In the example represented here, the output openings 51 are in the form of transverse slits. In variants, the output opening(s) 51 provided in the buccal tip can be of a number other than three, they can have different forms, and can be arranged in other locations of the buccal tip.

The buccal tip of the final part 5 in FIGS. 6 to 9 has a form which is generally suitable to be taken into a child's mouth. In the example represented in the figures, the buccal tip has an oblong cross section. The buccal tip is designed for drinking by deglutition such as would be done by subjects with milk teeth or adult teeth.

In the example described here, the final part 5 comprises a material and has a form and a thickness which are selected jointly in order to limit its deformation. The final part is designed to withstand use by a young child, the first teeth of whom (milk teeth) are in the process of appearing or have recently appeared, and who tends to chew the buccal tip. The embodiment represented in FIGS. 6 to 9 is particularly suitable for children aged over 18 months.

Reference is now made to FIGS. 10 to 13. The embodiment in FIGS. 10 to 13 is similar to that in FIGS. 6 to 9, with the exception of the final part 5. In this case, the final part 5 is centered at the top of the envelope 3, on the axis of revolution XX. This facilitates the production. As a variant, the final part 5 could be off-centered.

In this case, the final part 5 is in the form of a wall which extends the envelope 3 and at the top of the envelope 3. The final part 5 is distinguished from the envelope 3 which surrounds it by an annular rib 61 which projects upwards. In this case, the output opening 51 is in the form of two transverse grooves 63 which intersect at the axis of revolution XX, substantially at right-angles and delimited by the annular rib 61. The final part 5 thus forms a “straw opening”. The closing piece 1 is designed to dispense the drink by means of a straw 150 represented in FIGS. 15 and 16. The provision of the two grooves 63 in the final portion 5 creates four petals 65 or tongues, which extend from the annular rib 61 to the center of the portion, and the axis of revolution XX. The grooves 63 and the petals 65 of the final part 5 thus form exceptions to the symmetry of revolution of the closing piece 1.

Each of the four petals 65 is in contact or almost in contact with the two adjacent petals, such as to close the output opening 51 in a state of rest. The configuration of the final part 5 is reminiscent of that of a diaphragm obstructing the output opening 51 in a state of rest. The form, thickness and composition of the petals 65 are selected jointly to provide the petals 65 with flexibility and facilitate the manual insertion of the straw 150 through the output opening 51. The resulting resilient deformation of the petals 65 tends to retain the straw 150 in position, as represented in FIGS. 15 and 16.

In a state of rest, the petals 65 limit the leakage of liquid from the interior to the exterior of the closing piece 1, and continue to ensure this function when a straw 150 is inserted in the output opening 51, by ensuring adaptation of the output opening 51 according to the straw 150.

The output opening 51 which is designed to permit the insertion and retention of a straw 150 can have various forms and dimensions, and in particular a different number of petals or even a flap, or a mobile or deformable shutter.

The embodiment previously described is designed for adults or children with mastery of absorption of a beverage by suction by means of a straw. The embodiment in FIGS. 10 to 13 is in general suitable for children aged over 24 months.

According to variants, the closing piece 1 comprises an envelope 3 which is closed at its upper end 31 by at least two final parts 5 of one of the embodiments previously described. For example, a plurality of “straw openings” allow several individuals to drink together. According to yet other variants, the closing piece 1 comprises at least two final parts 5 of at least two of the preceding embodiments. A closing piece 1 of this type adapts easily according to the age and development of the children.

Reference is now made to the functioning of the flared part 43 which is common to each of the three embodiments previously described. The closing piece 1 is designed to cover a container 100 and close it hermetically by clamping. The container 100 forms a container for liquid which is open at the top and is designed to contain a drink, for example a glass or a goblet.

The container 100 is provided with a substantially cylindrical wall, a base and an orifice portion 101 which is open and surrounded by a periphery 103. In this case, periphery 103 means a recipient surface for the closing piece 1, which extends substantially vertically when the container 100 is placed on a horizontal surface. The periphery 103 is distinguished from an optional end surface 105 which is substantially horizontal and oriented upwards. In the example represented in FIGS. 15 and 16, the periphery 103 is in the form of a substantially cylindrical outer surface. The periphery 103 is situated in the vicinity of the open end of the container 100. The periphery 103 has a maximum outer diameter with the reference D₀.

The flared part 43 of the envelope 3 combines a material, thicknesses and characteristics, in particular of resilience and tearing, with the form of the flared part 43, which are selected in order to allow the contour of revolution of the envelope 3 to clamp efficiently the periphery 103 of the orifice portion 101 of various containers 100. The inner surface 45 then acts as a clamping surface.

In the assembled state, as represented in FIGS. 15 and 16, the closing piece 1 is in a constrained state, in this case drawn towards the exterior (widened or expanded) in the directions of its diameter. The state under resilient constraint of the elastomer of the flared part 43 generates a resilient return force. The resilient return force tends to return the perimeter of the flared part 43 to its value of rest. The return force is thus oriented according to the direction of the circumference of the contour of revolution, around the axis of revolution XX. The return force for its part generates a clamping force which is oriented according to radial directions, from the exterior towards the axis of revolution XX. The return force and the clamping force tend to return said flared part 43 to its state of rest, and therefore to reduce its diameter to its value at rest. The mechanisms in play are comparable to those of an annular elastic band. In the example represented here, the homogenous return force on the circumference, combined with the circular form of the container 100, generate a substantially homogenous clamping force on the circumference.

This clamping force makes it possible to apply at least part of the flared part 43 against the periphery 103 of the container 100. The clamping force generates sealing by surface contact between at least part of the inner surface 45 and the periphery 103 of the container 100.

In this case, the flared part 43 of the envelope 3 has characteristics which permit resilient deformation of the circumference of the contour of revolution with a factor which is at least equal to 2, and is preferably at least equal to 2.5. The flared part 43 can thus be expanded until it reaches a maximum diameter which must be greater than the maximum diameter D₀ of the portion of the container 100 around which the closing piece 1 must be fitted.

In the example in FIG. 16, the maximum diameter D₀ of the portion of the container 100 is situated at the top end of the container 100, the portion being provided with an outer rib 107. Containers 100, the maximum diameter D₀ of which is between 50 and 100 mm can be selected. Conventional containers in the field of cookery which are designed to contain beverages are habitually contained in this range of values, for example those of the glass, goblet, cup, mug type etc. For other containers 100 not represented, the maximum diameter D₀ corresponds to portions other than that of the end, for example for containers 100, the wall(s) of which flare(s) at least partially towards the exterior, in a direction oriented from the upper opening towards the base. It is not important for portions of the container 100 which are not covered by the closing piece 1 to have a diameter larger than the maximum outer diameter D₀.

The plurality of diameters induced by the flared form of the flared part 43 provides the closing piece 1 with a plurality of diameters in the state of rest, in this case between D₂₀ and D₁₀. In the example, D₂₀ represents the smallest diameter, whereas D₁₀ represents the largest. Each of the sections has respectively an expanded diameter D₂₀₊ to D₁₀₊ corresponding to each of the expanded diameters D₂₀ to D₁₀ up to the limit of resilience. Each of these sections has a range of diameters [D₂₀;D₂₀₊], . . . , [D₁₀;D₁₀₊] wherein said section retains deformation performance according to a resilient state.

If a container 100 has a maximum outer diameter D₀ which is smaller than, or equal to, the upper limit of a range, for example D₀≦D₁₀₊, then the corresponding section can surround the container 100.

Once it is expanded, the section of the closing piece 1 is subjected to a resilient force which tends to reduce its perimeter. If the maximum diameter D₀ of the container 100 is strictly larger than the lower limit of a range, for example D₂₀<D₀, then the state under resilient constraint of said section of the envelope 3 and the peripheral contact between the latter and the container 100 generate a clamping force between the two parts. The clamping force forms sealing and opposes the sliding of the closing piece 1 around the container 100. The closing piece 1 is retained in place. The closing piece 1 fits on the container 100 in a sealed manner.

If a section of the envelope 3 complies with the two preceding inequations for a given section, for example D₁₀<D₀≦D₁₀₊, then said section can not only be fitted around the container 100, but can also fit on it in a sealed manner by means of a non-zero clamping force. For a given section, a series of containers 100, the maximum outer diameter D₀ of which is contained in the corresponding range of dimensions, can each be covered by said closing piece 1, and fitted in a sealed manner by said section of the envelope 3. The section then acts as a clamping section.

The ranges of diameters [D₂₀; D₂₀₊], . . . , [D₁₀; D₁₀₊] together constitute a range in which each section can act as a clamping section according to the maximum outer diameter D₀ of the container 100. In the example described here, the flared part 43 has a series of sections with substantially continuous diameters in the axial direction XX, to within the ribs 47. The ranges of diameters [D₂₀; D₂₀₊], . . . , [D₁₀; D₁₀₊] overlap. The ranges of diameters [D₂₀; D₂₀₊], . . . , [D₁₀; D₁₀₊] together constitute a continuous range of diameters [D₂₀; D₁₀] It is sufficient for the maximum outer diameter D₀ to be contained in said range [D₂₀; D₁₀₊] in order to guarantee that the flared part 43 comprises at least one section which can act as a clamping section, and that the closing piece 1 can not only be fitted around the container 100, but can also fit it in a sealed manner. This can lead to fulfillment of the following double inequation: D₂₀<D₀≦D₁₀₊.

A large part of the existing containers for beverages have a generally substantially cylindrical form and a substantially circular opening portion. The examples of closing pieces 1 previously described have a form which is adapted to these containers and to a substantially circular form.

The substantially circular form of the closing piece 1 and its properties relative to the symmetry of revolution also allow the user to dispense with problems of orientation of the closing piece 1 relative to the container 100 during the assembly. Indexing in rotation is unnecessary.

When a circular form is involved, the inequations expressed according to diameters apply.

However, the flared part 43 is resilient, and therefore deformable. The flared part 43 can therefore adopt a section with a form different from that of a circle, in the expanded state in particular. A container 100 with a form other than circular can thus be covered by the closing piece 1 with a circular form and vice versa. The substantially circular form of the closing piece 1 permits adaptation to forms of periphery 103 of containers 100 which are closed and defined by one or a plurality of flat and/or convex walls. In the case of a closing piece 1 which is fitted on a container 100, one and/or the other of which has a form other than circular, the clamping force is not necessarily homogeneous around the circumference.

As a variant, the closing piece 1 itself can have a form which is square, rectangular, oval, hexagonal, or any other form with a closed contour, for example in order to have correspondence with an improved form with containers 100 with a particular form. In this case, the preceding inequations can be transposed to the perimeters. If the maximum perimeter in the expanded state at the limit of resilience of the clamping section is equal to, or larger than, the maximum outer perimeter of the portion to be covered of the container 100, then the closing piece 1 can be fitted on the container 100, if necessary by means of heterogeneous deformation, in order to obtain correspondence of forms.

The following generalized inequation can be deduced from this: P₀≦P₁₀₊ allowing the section to surround the container 100, where P represents a perimeter and where P=D×π in the particular case of circular forms.

The closing piece 1 adapts to containers 100, the maximum outer perimeter (P₀) of which, whether circular or not, is smaller than, or equal to, the inner perimeter of at least one section of the flared part 43 in an expanded state at the limit of resilience (P₁₀₊). In this case, said section has a range of resilience between the perimeters P₁₀ and P₁₀₊ and can be expanded resiliently in order to surround the container 100.

Containers 100, the maximum perimeter (P₀) of which is contained between 50 multiplied by Pi mm and 100 multiplied by Pi mm can be selected (50π≦P₀≦100π). This corresponds to a large part of the existing containers which can be used as gauges or references.

Preferably, the minimum perimeter at rest of the flared part 43 (in this case P₂₀), the lower limit of the range of use planned for the perimeter of the containers 100 (in this case 50 mm multiplied by Pi) and the resilience tensor (reference k) are jointly selected such that the friction force of the closing piece 1 on the container 100 (with the reference F) is greater than a given threshold value. The threshold value can correspond to a value of tearing force of the closing piece 1 of the container 100 oriented according to the axis of revolution XX which the assembly must withstand. This value can in particular be determined by a standard in force in the field of childcare. For example, in France and in Europe, the standard NF EN 14350-1 of 2004 describes tests of resistance to tearing at 90 (±5) Newton. This can be obtained for example by complying with the following in equation taken from the laws of mechanics of continuous mediums:

k×(50−D₁₀)≧F=90 Newtons, wherein the resilience tensor k is defined according to the forms of the closing piece 1 and of Young's modulus (E).

The resilient performance of the closing piece 1 is selected in order to make it possible to fit the closing piece 1 partially around the periphery 103 of a container 100 by means of manual widening of the flared part 103. Preferably, the resilient performance of the closing piece 1 is designed to have resistance to widening (once fitted) which is both substantial relative to the strength of a child, and reasonable relative to the strength of an adult. Thus, the accidental removal by a child of the closing piece 1 from the container 100 is limited.

According to the genesis of the invention, the embodiments previously proposed are designed for humans, in particular as far as the forms and dimensions are concerned. However the embodiments are not limited to this. In particular, closing pieces can be designed for use in the veterinary field and in particular that of mammals which are subject to suckling.

The invention is not limited to the examples described above purely by way of example, but incorporates all the variants which persons skilled in the art can envisage within the context of the following claims.

The invention can also be seen as a closing piece for beverage containers comprising an envelope and a final part made of food grade sealing elastomer material, the envelope having a general form substantially of revolution, an end of which is closed by the final part in which an output opening is provided in order to dispense the beverage, and the other end of which is designed to be engaged on a container, the envelope having in the vicinity of said other end a contour of revolution comprising a part which flares towards the exterior in the direction of said other end, the material of said flared part of the envelope combining thicknesses, and characteristics, of resilience and resistance to tearing at least, with the form of said flared part permitting resilient deformation of at least a portion of the contour of revolution of the envelope, between a state of rest and an expanded state, said portion having a perimeter in the expanded state which is more than twice that of a perimeter in the state of rest.

The invention can also be seen as a closing piece for beverage containers, comprising an envelope in a single piece with a general form of revolution, made of food grade sealing elastomer material, said envelope having a first end provided with a final part, an output opening in order to dispense the beverage being provided in said final part, the second end of the envelope being designed to be connected to a container in the vicinity of said second end, the envelope having a part which is flared in the direction of the second end, the form of said flared part and its constituent material, with their thicknesses and resilient characteristics, being determined in order to permit a plurality of ranges of resilient deformation of the flared part, according to the portion of the latter which is deformed in a state in which it is connected to a container, said plurality of deformation ranges being selected in order to fit in a sealed manner a range of containers with different opening sizes.

1. A closing piece (1) for beverage containers, comprising an envelope (3) with a generally tubular form made of food grade sealing elastomer material;
this envelope (3) having a first end (31) closed by a final part (5) also made of food grade sealing elastomer material, whereas an output opening (51) to dispense the beverage is provided in this final part (5); the second end (41) of the envelope (3) being designed to be connected to a container,
characterized in that in the vicinity of this second end (41), the envelope (3) has a part (43) which is flared in the direction of the second end (41); the form of this flared part (43) and its component material, with their thicknesses and resilient characteristics, being determined in order to permit a plurality of ranges of resilient deformation of the flared part (43), according to the portion of it which is deformed in a state in which it is connected to a container, this plurality of deformation ranges being selected in order to make it possible to fit in a sealed manner on a range of containers which have openings with different sizes.

2. The closing piece (1) as claimed in claim 1, wherein the plurality of deformation ranges is selected in order to make it possible to fit in a sealed manner on a range of containers which have substantially circular openings with diameters of between 50 and 100 mm.

3. The closing piece (1) as claimed in claim 1, wherein the first end (31) and the flared part (43) of the envelope (3) are in a single piece and made of a common material.

4. The closing piece (1) as claimed in claim 1, wherein the flared part (43) of the envelope (3) comprises a first material and the first end (31) of the envelope (3) comprises a second material with hardness greater than that of the first material.

5. The closing piece (1) as claimed in claim 1, wherein the thickness of the flared part (43) of the envelope (3) is between 500 and 1,000 μm.

6. The closing piece (1) as claimed in claim 1, wherein, between the end (31), which is closed by the final part (5), and the flared part (43), the envelope (3) comprises a radial restriction towards the interior.

7. The closing piece (1) as claimed in claim 1, wherein the envelope (3) comprises silicone with Shore A hardness of between 10 and 70.

8. The closing piece (1) as claimed in claim 1, wherein the first end (31) of the envelope (3) comprises silicone with Shore A hardness of between 10 and 80.

9. The closing piece (1) as claimed in claim 1, wherein, in the vicinity of the free end of the second end (41), the envelope (3) comprises a bead (49) extending substantially on a contour, and which projects towards the exterior according to a substantially radial direction.

10. The closing piece (1) as claimed in claim 1, wherein the end of the second end (41) is without a collar.

11. The closing piece (1) as claimed in claim 1, wherein the flared part (43) has an inner clamping surface (45), the inner clamping surface (45) being provided with at least one rib (47) which extends substantially in a circumferential direction.

12. The closing piece (1) as claimed in claim 1, wherein the final part (5) forms a protuberance relative to the envelope (3) and is connected to the latter by means of a bottleneck, the [mal part (5) being designed for suckling by suction-deglutition of nursing infant type.

13. The closing piece (1) as claimed in claim 1, wherein the final part (5) comprises a buccal tip which is designed for drinking by deglutition such as would be done by a subject with milk teeth or adult teeth.

14. The closing piece (1) as claimed in claim 1, wherein the output opening (51) for dispensing the beverage is designed to permit insertion and retention of a straw.
